(19) United States
(12) Patent Application Publication
(10) Pub. No.: US 2005/0036542 A1
(43) Pub. Date: Feb. 17, 2005

(54) Computation of compressed video information

(76) Inventors: Wilhelmus Antonius Hubertus Van Halen, Hasselt (BE); Wilhelmus Hendrikus Alfonsus Bruls, Eindhoven (NL); Gerardus WilhelmusTheodrus Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,831

(22) PCT Filed: Dec. 12, 2002
(86) PCT No.: PCT/IB02/05497

(30) Foreign Application Priority Data
Jan. 22, 2002 (EP) 02075252.3

(51) Int. Cl. H04N 7/12

(52) U.S. Cl. 375/240.01

(57) ABSTRACT

During image compression alternative video compression technique are selected under control of an extent to which a computational resource is detected to be available for compression. A less or more resource intensive compression technique is used when more of the resource is available respecrtively. At least part of a frame from a sequence of frames from the video information is encoded alternatively using a first process by means of change information relative to a neighboring frame or using a second process independent from any neighboring frame in said sequence, dependent on the extent to which the resource is available it is selected to encode.

The invention relates to an apparatus for compressing video information and to a method of operating such an apparatus.

From U.S. Pat. No. 5,508,743 a compression apparatus is known. Various techniques are known for the compression of video (moving image) information. These techniques aim to reduce the amount of bandwidth required to transmit or store the compressed video information, while maximizing the quality of the image that can be obtained upon decoding of the compressed video information.

MPEG is a well known series of standards for representing compressed video information. Strictly speaking MPEG prescribes only decoding techniques, but of course the allowable decoding techniques also have implications for encoding and compression. Each MPEG decoding standard supports various forms of compression of video information. For example, some of the frames in a sequence of frames that makes up the video information (so-called P frames and B frames) may be encoded in terms of changes with respect to neighboring frames in the sequence. Only part of the frames (so-called I frames) have to be encoded independently of other frames. Another compression technique supported by MPEG is to divide the frames into rectangular blocks, to compute, for each block, a digital cosine transformation of the information in the blocks and to set the quantization level of different elements of the transformed information selectively so that a minimum of visible artefacts occur in the decoded image.

Various compression techniques have been developed to optimize the image quality of a compressed image with a limited amount of bandwidth that can be decoded in real time (at the rate at which the video information has to be displayed, for example with 50 or 60 frames per second) with a limited amount of computational resources for decoding. U.S. Pat. No. 5,508,743 for example, selects the rate at compression switches between encoding changes between frames and encoding independent of neighboring differently for different blocks. U.S. Pat. No. 5,508,743 describes that this rate can be adapted after abrupt image changes so as to reduce the bandwidth required for the signal.

This kind of technique ensures that decoding (decompression) can be performed in real time by a specified decoding apparatus, often an apparatus dedicated to decoding. The computational operations needed for compression on the other hand can, in principle, be performed by any computing apparatus. This changes when real time compression operation is needed (compression at the rate at which the video information arrives, for example with 50 or 60 frames per second). In this case the compression apparatus has to be designed with a sufficient amount of computational power to perform compression.

It is desirable to perform video signal compression with a programmable computer that can be used for several tasks concurrently, that is, not only for encoding the video signal. In this case, a sufficient amount of computational resources has to be reserved for the real time compression task, the remaining tasks getting only the remainder of the resources, or whatever resources are left over when fewer resources are temporarily needed for compression due to the content of the video information. This means that a very powerful and therefore expensive computer is needed for real time compression.

Amongst others, it is an object of the invention to provide for a real time compression technique that requires a less powerful computer and/or leaves more room to perform other tasks concurrently with real time compression.

The invention provides for a method of computing compressed video information with a computing device, the method comprising automatically selecting a compression technique used by the computing device under control of an extent to which a computational resource for compression is detected to be available in the computing device, a less or more resource intensive compression technique being selected when the extent is below or in excess of a threshold respectively.

Thus the compression rate is controlled dependent on the available computational resources. Preferably, the quality of the compressed image is kept substantially constant, at the expense of higher bandwidth when less of the computational resource is available. This should be distinguished from conventional techniques which aim to adapt the compression technique according to bandwidth limitations (bandwidth not being a computational resource). In the latter technique more compression, or even complete suppression of information is normally used when the limits of the available bandwidth are reached. In contrast, according to the present invention less compression is used when the limits of computational resources are reached.

Preferably, the method comprises selecting, dependent on said extent, between encoding at least part of a frame from a sequence of frames from the video information alternatively using a first process by means of change information relative to a neighboring frame or a second process independent from any neighboring frame in said sequence, the first or second process being selected when said extent is below or below the threshold respectively. Thus, in an MPEG encoding process more I frames are used when little resources are available for encoding and more P or B frames are used when more resources are available. Of course, a minimum number of I frames may be included independent of the available resources as required according to MPEG recommendations.

Selection between independent coding and change coding, which latter requires more computational resources than independent coding but leads to a greater compression rate than independent coding, is a simple an effective way to realize adaptation of resources used for encoding. Of course, other ways of adaptation may also be used, such as adaptation of the resolution of the frames that are compressed.

The method may preferably be used in a multitasking computer, in which case the rate of compression is selected dependent on the resources left by other tasks executed by the processor.

These and other advantageous aspects and advantages of the apparatus and method according to the invention will be described using the following figures.

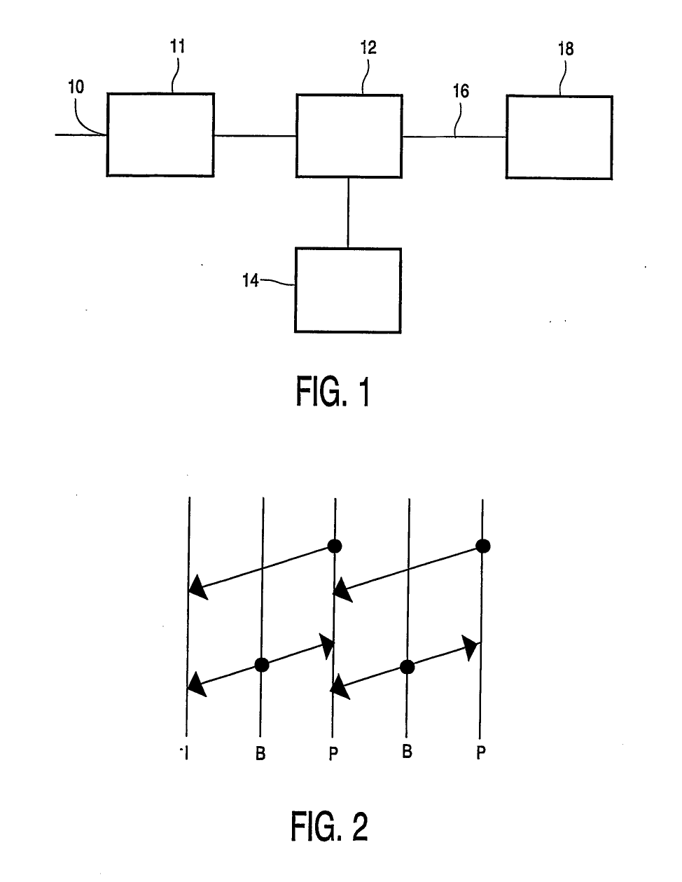

FIG. 1 shows a system for processing video information

FIG. 2 shows relations between encoded frames of video information.

FIG. 1 shows a system with an input 10 for receiving video information, an input memory 11, a processor 12, a working memory 14, a transfer medium 16 and a decompression apparatus 18. The input 10 is coupled to the input memory 11. The processor 12 is coupled to the input memory 11, the working memory 14 and the medium 16. The decompression apparatus 18 is coupled to the medium 16.

In operation, a video signal that comprises video information describing a sequence of frames (two-dimensional images) arrives at input 10. The video information is stored in input memory 11. Processor 12 reads the video information from input memory 11 an compresses the video information (using working memory 14 for intermediate information) and sends the compressed information to medium 16. Medium 16 is for example a memory device (such as a hard disk, an optical disk, a magnetic tape etc.) or a transmission channel such as a data bus or a broadcast channel. Decompression apparatus 18 reads the compressed video information from medium 16, decompresses this information and displays it on a display screen (not shown), or subjects it to further processing.

Compression is performed by processor 12 for example in order to obtain a compressed signal in accordance with an MPEG standard. Within the definition of compressed video signals according to the MPEG standard several types of compression are known. One of these is the use of prediction of the content of frames from the content of directly or indirectly neighboring frames. Examples of this kind of prediction are single direction prediction (forward or backward, from a preceding or following frame) and interpolation between frames in two directions.

FIG. 2 illustrates the relation between different frames according to the MPEG standards. Display time runs in the horizontal direction. A number of successive frames (or pictures) from the video signal, labelled I, B and P are indicated successively. An I frame (or I picture) is a frame that can be decoded independently of the other frames. A P frame is a frame that is decoded by reference to (extrapolation from) a preceding or following frame, usually a preceding frame. In FIG. 2 this kind of reference is indicated by arrows pointing at the frame from which the P frame is derived during decoding. A B frame is a frame that is decoded by interpolation between neighboring frames in forward and backward directions. In FIG. 2 the frames from which the B frame is interpolated are indicated by arrows from the B frame.

The relation between P frames or B frames and the frames they refer to may be expressed for example in terms of displacement vectors. The idea behind this is that the content of the frames does not change very much from one frame to another and even then only mainly by displacement of areas (e.g. moving objects) from one position in one frame to another position in another (neighboring) frame. As a result the content of that other frame can be expressed by means of vectors that represent the displacements of different areas in the frame and optionally some correction information for correcting inaccuracies of such a prediction (the displacement vectors being carefully selected to minimize the inaccuracies).

When B frames or P frames are used the processor 12 has to search for values of the displacement vectors that minimize the inaccuracies of the prediction or interpolation of the B or P frame. This requires a large amount of computational effort, involving for example computation of correlation coefficients between each area from one frame and a number of areas from another frame. More effort is needed to make full use of B frames than for P frames since area's from two neighboring frames need to be compared in case of B-frames instead of one as in the case of P frames.

Processor 12 is preferably a multitasking processor, capable of executing one or more other tasks concurrently with the compression task. That is, it runs under control of an operating system that computes how much of the computational resources of the processor are in use by various tasks and makes unused computational resources available to the tasks. Thus, the different tasks share various computational resources of the processor 12. In an example of sharing computational resources the tasks may run alternately on processor 12, each getting a fraction of processing time. In another example each task may be allowed to use only its own fraction of working memory 14 (or local processor 12 memory), to use certain co-processors etc.

In principle a fixed amount of resources, sufficient for compression, could be reserved for the compression task. However, if the compression task were limited to such a fixed amount, the amount of compression (which grows in with to the amount of computational effort used) would thus need to be limited or little computational resources would be left for the other task.

According to the invention, this is circumvented by adapting the amount of compression according to the amount of computational resources left over by the other tasks. In a particular embodiment, a choice whether to encode a frame on one hand as an I frame or on the other hand as a B or P frame, is made under control of a signal representing this amount of computational resources.

Preferably, compression is executed by processor 12 under control of a computer program that selects whether to use an I frame, a P frame or a B frame for encoding a frame of the incoming video information. The program makes a basic selection of frames that are to be encoded as I frames on the basis of the needs of MPEG encoding, for example the need to have an independently coded frame every so many milliseconds. The program selects to encode one or more of remaining frames as on one hand I frames or on the other hand encoded as B or P frames dependent on whether less or more than a minimum amount of resources are available respectively. In a further embodiment a selection is even made whether to encode a frame as a B frame or a P frame dependent on the available resources, a P frame (one directional prediction) being selected when relatively less resources are available.

Thus, a higher compression rate is realized when the other tasks leave more resources free and a lower compression rate is realized when the other tasks leave fewer resources free. In principle the other task may be of any kind that can be executed by the processor 12, including possibly other image compression tasks. In an embodiment, there need not even be other tasks, the amount of resources left over being resources left over by the compression task itself, dependent on the nature of the video signal being compressed.

Thus, the image quality of the compressed image can be kept more or less constant with a variable amount of computing resources, be it at the expense of a variable use of bandwidth in medium 16.

It will be appreciated that the invention can be applied to any kind of processor 12 that is capable of executing a compression task. Preferably, processor 12 is a general purpose processor 12 such as a MIPS processor or a VLIW processor, but the inventions may be applied to more specialized processors such as signal processors as well.

Although the invention has been explained in terms of the selection whether or not to encode a frame independent of other frames or in terms of changes to one or more neighboring frames under control of a signal representing the availability of resources, it will be appreciated that the adaptation to the available resources can also be applied to other aspects of compression. For example to adaptation of the resolution with which the video information is encoded.

1. A method of computing compressed video information with a computing device (18), the method comprising automatically selecting a compression technique used by the computing device (18) under control of an extent to which a computational resource for compression is detected to be available in the computing device (18), a less or more resource intensive compression technique being selected when the extent is below or in excess of a threshold respectively.

2. A method according to claim 1, comprising selecting, dependent on said extent, between encoding at least part of a frame from a sequence of frames from the video information alternatively using a first process by means of change information relative to a neighboring frame or a second process independent from any neighboring frame in said sequence, the first or second process being selected when said extent is below or below the threshold respectively.

3. A computing apparatus (18) arranged to compress video information, the computing apparatus (18) being arranged to adapt a compression technique under control of an extent to which a computational resource for compression is detected to be available in the computing apparatus (18), a less or more resource intensive compression technique being selected when the extent is below or in excess of a threshold respectively.

4. A computing apparatus (18) according to claim 4, arranged to execute a plurality of tasks concurrently, each task using a share of the computational resource of the apparatus (18), the tasks including said compression of video information and one or more remaining tasks, wherein the computing apparatus (18) is arranged to select the compression technique dependent on a size of a remaining share of the computational resource that is not used by the one or more remaining tasks.

5. A computing apparatus (18) according to claim 3, arranged to select between encoding at least part of a frame from a sequence of frames from the video information alternatively using a first process by means of change information relative to a neighboring frame in said sequence or using a second process independent of any neighboring frames in said sequence, the computing apparatus (18) comprising means to select between the first and second process under control of a signal that represents said extent, the first or second process being selected when said extent is below or the above threshold level respectively.

6. A computer program product comprising a computer program arranged to cause a computing apparatus (18) to compress video information, the compression being arranged to adapt a compression technique under control of an extent to which a computational resource for compression is detected to be available in the computing apparatus (18), a less or more resource intensive compression technique being selected when the extent is below or in excess of a threshold respectively.
